(19) United States
(12) Patent Application Publication
(10) Pub. No.: US 2003/0105223 A1
(43) Pub. Date: Jun. 5, 2003

(54) Pu-modified miniemulsion polymers

(76) Inventors: Ulrike Licht, Mannheim (DE); Sabine Kielhorn-Bayer, Maxdorf (DE); Karl Haberle, Speyer (DE)

Correspondence Address: OBLON, SPIVAK, MCCLELLAND, MAIER & NEUSTADT, P.C., FOURTH FLOOR, 1755 JEFFERSON DAVIS HIGHWAY, ARLINGTON, VA, 22202, US

(21) Appl. No.: 10/257,949

(22) PCT Filed: Apr. 17, 2001
(86) PCT No.: PCT/EP01/04310

(30) Foreign Application Priority Data
Apr. 25, 2000 (DE) 100 20 195.4

(51) Int. Cl. C08K 3/00

(52) U.S. Cl. 524/832

(57) ABSTRACT

An aqueous dispersion of a polymer, obtainable by polymerizing free-radically polymerizable compounds (monomers), which comprises dissolving or dispersing in the dispersed monomer droplets compounds P containing urethane and/or urea groups and containing at least one reactive end group, said compounds P containing no carbodiimide groups.

The invention relates to an aqueous dispersion of a polymer obtainable by emulsion polymerization of free-radically polymerizable compounds (monomers), which comprises dissolving or dispersing in the monomer droplets dispersed in water compounds P containing urethane and/or urea groups and containing at least one reactive end group, said compounds P containing no carbodiimide groups.

The invention additionally relates to processes for preparing the aqueous dispersion by miniemulsion polymerization and to its use as a binder.

Urethane-modified emulsion polymers are known from numerous documents, examples including DE-A-38 06 066, DE-A-19 645 761, and EP-B 815 152. A disadvantage of these processes is that they all require the preparation of a PU dispersion in an upstream process step. The prior document DE-A-19960864 discloses emulsion polymers with compounds containing carbodiimide groups.

It is an object of the present invention to provide emulsion polymers which in a cost-effective process can be modified with urethanes and/or ureas and/or isocyanates without the need to prepare a polyurethane dispersion beforehand. The aqueous dispersions should be stable on storage and should have good performance properties.

From the work of J. W. Gooch, H. Dong and F. J. Schork, Journal of Applied Polymer Science 76 (2000) 105-114, it is known to modify miniemulsion polymers with polyurethanes. However, they start only from a finished polyurethane, which is dissolved in the monomer mixture. The solubility in customary monomers limits the number of PU structures used to low molecular mass polymers with low urea contents. However, there is a desire for combinations of properties as achieved by mixtures of the two high polymers, partly branched or crosslinked (emulsion polymers and polyurethane ureas).

We have found that this object is achieved by the aqueous dispersion described at the outset. We have also found processes for preparing the dispersion and its use as binder.

Preferred end groups of the compounds P are: OH groups, NH groups, SH groups and NCO groups.

In one preferred embodiment, compound P contains NCO end groups.

Preferably, a compound P contains urethane groups.

With particular preference, compound P is a polyurethane or a polyurethaneurea containing isocyanate end groups.

It is preferred to react the following starting materials in a polyaddition reaction:

a) diisocyanates having 4 to 30 carbon atoms,

b) diols of which

b1) from 10 to 100 mol %, based on the overall amount of the diols (b), has a molecular weight from 500 to 5000, and

b2) from 0 to 90 mol %, based on the overall amount of the diols (b), has a molecular weight from 60 to 500 g/mol,

c) if desired, further polyfunctional compounds different from the structural components (a) to (b2), containing reactive groups which are alcoholic hydroxyl groups, primary or secondary amino groups or isocyanate groups, and

d) if desired, monofunctional compounds, different from the structural components (a) to (c), containing a reactive group which is an alcoholic hydroxyl group, a primary or secondary amino group or an isocyanate group.

If desired, hydrophilic or potentially hydrophilic structural components as described in DE 19733044 may also be used for components (b2), (c) and (d). However, they are of only minor significance since they destroy the cost advantage of the dispersions and disrupt the preferred miniemulsion polymerization process. Preferably they are not used.

Examples of suitable structural components (a) are:

diisocyanates X(NCO)₂, where X is an aliphatic hydrocarbon radical having 4 to 12 carbon atoms, a cycloaliphatic or aromatic hydrocarbon radical having 6 to 15 carbon atoms or an araliphatic hydrocarbon radical having 7 to 15 carbon atoms. Examples of such diisocyanates are tetramethylene diisocyanate, hexamethylene diisocyanate, dodecamethylene diisocyanate, 1,4-diisocyanatocyclohexane, 1-isocyanato-3,5,5-trimethyl-5-isocyanatomethylcyclohexane (IPDI), 2,2-bis-(4-isocyanatocyclohexyl)propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4′-diisocyanatodiphenylmethane, p-xylylene diisocyanate, tetramethylxylylene diisocyanate (TMXDI), the isomers of bis-(4-isocyanatocyclohexyl)methane (HMDI) such as the trans/trans, the cis/cis and the cis/trans isomer, and mixtures of these compounds.

From the standpoint of good film forming and elasticity, suitable diols (b) are ideally those of relatively high molecular mass (b1), having a molecular weight from about 500 to 5000, preferably from about 1000 to 3000, g/mol.

The diols (b1) are, in particular, polyesterpolyols, which are known, for example, from Ullmanns Encyklopädie der technischen Chemie, 4^{th} edition, Volume 19, pp. 62 to 65. Preference is given to the use of polyesterpolyols obtained by reacting dihydric alcohols with dibasic carboxylic acids. In place of the free polycarboxylic acids it is also possible to use the corresponding polycarboxylic anhydrides or polycarboxylic esters of lower alcohols, or mixtures thereof, to prepare the polyesterpolyols. The polycarboxylic acids may be aliphatic, cycloaliphatic, araliphatic, aromatic or heterocyclic and may be unsubstituted or substituted, for example, by halogen atoms, and/or unsaturated. Examples of such acids are suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, and dimeric fatty acids. Preference is given to dicarboxylic acids of the formula HOOC—(CH₂)_{y}—COOH, where y is a number from 1 to 20, preferably an even number from 2 to 20, examples being succinic, adipic, sebacic and dodecanedicarboxylic acid.

Examples of suitable polyhydric alcohols are ethylene glycol, propane-1,2-diol, propane-1,3-diol, butane-1,3-diol, butene-1,4-diol, butyne-1,4-diol, pentane-1,5-diol, neopentyl glycol, bis-(hydroxymethyl)cyclohexane such as 1,4-bis(hydroxymethyl)cyclohexane, 2-methylpropane-1,3-diol, methylpentanediols, and also diethylene glycol, triethylene glycol, tetraethylene glycol, polyethylene glycol, dipropylene glycol, polypropylene glycol, dibutylene glycol and polybutylene glycols. Preferred alcohols are of the formula HO—(CH₂)ₓ—OH, where x is a number from 1 to 20, preferably an even number from 2 to 20. Examples are ethylene glycol, butane-1,4-diol, hexane-1,6-diol, octane-1,8-diol and dodecane-1,12-diol.

Neopentyl glycol is additionally preferred.

Also suitable are polycarbonatediols as may be obtained, for example, by reacting phosgene with an excess of the low molecular mass alcohols mentioned as structural components for the polyesterpolyols.

Lactone-based polyesterdiols are also suitable, these being homopolymers or copolymers of lactones, preferably hydroxyl-terminated adducts of lactones with suitable difunctional starter molecules. Preferred lactones are those derived from compounds of the formula HO—(CH₂)_{z}—COOH, where z is a number from 1 to 20 and one hydrogen atom of a methylene unit may also be substituted by a C₁ to C₄ alkyl radical. Examples are epsilon-caprolactone, beta-propiolactone, gamma-butyrolactone and/or methyl-epsilon-caprolactone, and mixtures thereof. Examples of suitable starter components are the low molecular mass dihydric alcohols mentioned above as structural components for the polyesterpolyols. The corresponding polymers of epsilon-caprolactone are particularly preferred. Lower polyesterdiols or polyetherdiols may also be used as starters for preparing the lactone polymers. Instead of the lactone polymers it is also possible to employ the corresponding, chemically equivalent polycondensates of the hydroxy carboxylic acids corresponding to the lactones.

Other suitable structural components (b1) include polyetherdiols. They may be obtained in particular by polymerizing ethylene oxide, propylene oxide, butylene oxide, tetrahydrofuran, styrene oxide or epichlorohydrin with itself in the presence, for example, of BF₃ or by carrying out addition reactions of these compounds—individually, as a mixture or in succession—with starter components containing reactive hydrogen atoms, such as alcohols or amines, examples being water, ethylene glycol, propane-1,2-diol, propane-1,3-diol, 1,2-bis(4-hydroxydiphenyl)propane, or aniline. Particular preference is given to polytetrahydrofuran having a molecular weight from 240 to 5000 and, in particular, from 500 to 4500.

Likewise suitable are polyhydroxypolyolefins, preferably those having 2 terminal hydroxyl groups, examples being alpha,omega-dihydroxypolybutadiene, alpha,omega-dihydroxypolymethacrylates or alpha,omega-dihydroxypolyacrylates, as monomers (b1). Such compounds are known, for example, from EP-A-0 622 378. Further suitable polyols are polyacetals, polysiloxanes and alkyd resins.

The polyols may also be used as mixtures in a ratio of from 0.1:1 to 1:9.

As structural components (b2) use is made in particular of the structural components of the short-chain alkanediols specified for the preparation of polyesterpolyols, preference being given to unbranched diols having 2 to 12 carbon atoms and an even number of carbon atoms, and also pentane-1,5-diol and neopentyl glycol.

The fraction of the diols (b1), based on the overall amount of diols (b), is preferably from 10 to 100 mol %, and the fraction of the structural components (b2), based on the overall amount of diols (b), is preferably from 0 to 90 mol %. With particular preference, the ratio of the diols (b1) to the structural components (b2) is from 0.1:1 to 5:1, with particular preference from 0.2:1 to 2:1.

The structural components (c), which are different from components (a) and (b), serve generally for crosslinking or chain extension. Generally, they are nonphenolic alcohols with a functionality of more than 2, amines containing 2 or more primary and/or secondary amino groups, and compounds which in addition to one or more alcoholic hydroxyl groups carry one or more primary and/or secondary amino groups.

Alcohols having a functionality of more than 2, which can be used to establish a certain degree of branching or crosslinking, are, for example, trimethylolpropane, glycerol or sugars.

Also suitable are monoalcohols which in addition to the hydroxyl group carry a further isocyanate-reactive group, such as monoalcohols containing one or more primary and/or secondary amino groups, an example being monoethanolamine.

Amines suitable for this purpose are, in general, polyfunctional amines from the molar weight range from 32 to 500 g/mol, preferably from 60 to 300 g/mol, which contain at least two amino groups selected from the group consisting of primary and secondary amino groups. Examples thereof are diamines such as diaminoethane, diaminopropanes, diaminobutanes, diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate, or triamines such as diethylenetriamine or 1,8-diamino-4-aminomethyloctane.

For the same purpose it is also possible as structural components (c) to use isocyanates having a functionality of more than two. Examples of commercially customary compounds are the isocyanurate or the biuret of hexamethylene diisocyanate.

Structural components (d), whose use is optional, are monoisocyanates, monoalcohols and mono-primary and mono-secondary amines. In general, their fraction is not more than 10 mol %, based on the overall molar amount of the structural components. These monofunctional compounds may carry further functional groups such as olefinic groups or carbonyl groups and are used to introduce functional groups into the polyurethane which permits crosslinking or subsequent polymer-analogous reaction of the polyurethane. Structural components suitable for this purpose are those such as isopropenyl alpha,alpha-dimethylbenzyl isocyanate (TMI) and esters of acrylic or methacrylic acid such as hydroxyethyl acrylate or hydroxyethyl methacrylate.

Preferably, compounds P contain no double bonds, apart from those in aromatic systems.

The polyaddition of components (a) to (d) takes place generally at reaction temperatures from 20 to 180° C., preferably from 50 to 150° C., under atmospheric or the autogenous pressure.

The reaction takes place preferably in the melt or in a solution of compounds which are inert toward isocyanates. Particular preference is given to the use as solvents of the monomers from which the polymer is subsequently prepared.

The reaction times required may extend from a few minutes to several hours. It is known in the field of polyurethane chemistry how the reaction time may be influenced by a large number of parameters such as temperature, monomer concentration, and reactivity of the structural components.

The reaction of the diisocyanates may be accelerated using the customary catalysts, such as dibutyltin dilaurate, tin(II) octoate or diazabicyclo[2.2.2]octane.

The amount of reactive end groups, especially the isocyanate groups, in compound P is from 0.1 to 10%, preferably 0.5-5%, calculated from the molar ratios of the reactive starting compounds.

The isocyanate-containing compounds P hydrolyze in the dispersion and form high molecular mass polyurethane ureas, which have particularly advantageous performance properties.

Particular preference is given to functionalities (average value per molecule) of the reactive end groups in the compounds P of from 1.5 to 3.

Where the compounds P are synthesized with an NCO functionality >2, easily crosslinked polyurethane urea/acrylate hybrids are obtained.

The dispersions of the invention are preferably prepared by miniemulsion polymerization of ethylenically unsaturated compounds (monomers) in the presence of the compounds P. The amount of compound P is 1%-90% by weight, based on the total weight of monomers and compound P, preferably 5%-50%, with particular preference 10%-30%.

The preferred process for preparing the aqueous dispersion of the invention is the method of miniemulsion polymerization. This process is generally conducted by way of a first step in which an emulsion E1 is produced from a mixture of the monomers to be polymerized and the PU prepolymer, these monomer droplets in said emulsion E1 having a diameter of <1000 nm and preferably in the range from 50 to 500 nm. Subsequently, the emulsion E1 is contacted with at least one initiator under temperature conditions at which the initiator initiates free-radical polymerization of the ethylenically unsaturated compounds. The average size of the droplets of the dispersed phase of the aqueous emulsion E1 for use in accordance with the invention may be determined in accordance with the principle of quasielastic light scattering (the so-called z-average droplet diameter dz of the unimodal analysis of the autocorrelation function). In the examples, a Coulter N4 Plus Particle Analyzer from Coulter Scientific Instruments was used for this purpose (1 bar, 25° C.). The measurements were performed on dilute aqueous emulsions E1 in which the amount of nonaqueous constituents was 0.01% by weight. Dilution was performed using water which had been saturated beforehand with the monomers present in the aqueous emulsion. These measures are intended to prevent the dilution being accompanied by any change in droplet size.

In accordance with the invention, the values thus determined for the emulsion E1 for dz are normally <1 μm, frequently <0.5 μm. In accordance with the invention, the dz range is favorably from 100 nm to 300 nm or from 200 to 300 nm. In the normal case, dz in the aqueous emulsions E1 for use in accordance with the invention is >40 nm.

The emulsion E1 may be prepared using, for example, high-pressure homogenizers. In these machines the fine distribution of the components is obtained by means of a high local energy input. Two variants have proven particularly appropriate in this context:

In the first variant, the aqueous macroemulsion is compressed to more than 1000 bar using a piston pump and is then released through a narrow gap. The action here is based on an interplay of high shear gradients and pressure gradients and cavitation in the gap. One example of a high-pressure homogenizer which functions in accordance with this principle is the Niro-Soavi high-pressure homogenizer model NS1001L Panda.

In the second variant, the compressed aqueous macroemulsion is released into a mixing chamber by way of two mutually opposed nozzles. In this case, the action of fine distribution depends above all on the hydrodynamic conditions within the mixing chamber. One example of this type of homogenizer is the model M 120 E from Microfluidics Corp. In this high-pressure homogenizer, the aqueous macroemulsion is compressed by means of a pneumatic piston pump to pressures up to 1200 atm and is released through an “interaction chamber”. In the interaction chamber the emulsion jet is divided in a microchannel system into two jets which are caused to collide at an angle of 180°. Another example of a homogenizer operating in accordance with this mode of homogenization is the Nanojet model Expo from Nanojet Engineering GmbH. With the Nanojet, however, instead of a fixed channel system, two homogenizing valves are installed which can be adjusted mechanically.

In addition to the principles just mentioned, homogenization may also be brought about, for example, by the use of ultrasound (e.g., the Branson Sonifier II 450). In this case the fine distribution is the result of cavitation mechanisms. For ultrasonic homogenization, the apparatus described in GB 22 50 930 A and the apparatus described in U.S. Pat. No. 5,108,654 are also suitable in principle. The quality of the aqueous emulsion E1 produced in the sonic field depends not only on the sonic power input but also on other factors, such as the intensity distribution of the ultrasound in the mixing chamber, the residence time, the temperature, and the physical properties of the substances to be emulsified, for example, the viscosity, surface tension, and vapor pressure. The resulting droplet size depends in this case, inter alia, on the concentration of the emulsifier and on the energy input for homogenization, and may be adjusted specifically by making a corresponding change, for example, in the homogenization pressure and/or in the corresponding ultrasound energy.

For preparing the emulsion E1 from conventional emulsions by means of ultrasound, the device described in prior German Patent Application DE 197 56 874.2 has proven particularly appropriate. This is a device having a reaction chamber or a through-flow reaction channel and at least one means of transmitting ultrasonic waves to the reaction chamber or to the through-flow reaction channel, said means being configured so that the entire reaction chamber, or the through-flow reaction channel in a subsection, may be sonicated uniformly with ultrasonic waves. For this purpose, the emitting surface of the means of transmitting ultrasonic waves is designed in such a way that it corresponds essentially to the surface of the reaction chamber and, if the reaction chamber is a subsection of a through-flow reaction channel, extends essentially over the entire width of the channel, and in such a way that the reaction chamber depth which is essentially vertical with respect to the emitting surface is lower than the maximum effective depth of the ultrasound transmission means.

The term “reaction chamber depth” refers here essentially to the distance between the emitting surface of the ultrasound transmission means and the floor of the reaction chamber.

Reaction chamber depths of up to 100 mm are preferred. The depth of the reaction chamber should advantageously not be more than 70 mm, and with particular advantage not more than 50 mm. The reaction chambers may in principle also have a very small depth, although in view of a minimal risk of clogging, maximum ease of cleaning, and high product throughput, preference is given to the reaction chamber depths which are substantially greater than, for instance, the customary gap heights in high-pressure homogenizers, and usually more than 10 mm. The reaction chamber depth is advantageously alterable by means, for example, of ultrasound transmission means which enter the housing to different extents.

In accordance with a first embodiment of this device, the emitting surface of the means of transmitting ultrasound corresponds essentially to the surface of the reaction chamber. This embodiment is used for the batchwise production of emulsions E1. With this device, ultrasound is able to act on the entire reaction chamber. In the reaction chamber, the axial pressure of sonic irradiation produces a turbulent flow which brings about intensive cross-mixing.

In accordance with a second embodiment, a device of this kind has a through-flow cell. In this case the housing is designed as a through-flow reaction channel, with an inlet and an outlet, the reaction chamber being a subsection of the through-flow reaction channel. The width of the channel is that extent of the channel which runs essentially normal to the flow direction. Therefore, the emitting surface covers the entire width of the flow channel transversely to the flow direction. That length of the emitting surface which is perpendicular to this width, in other words the length of the emitting surface in the flow direction, defines the effective range of the ultrasound. In accordance with one advantageous variant of this second embodiment, the through-flow reaction channel has an essentially rectangular cross section. If a likewise rectangular ultrasound transmission means of appropriate dimensions is installed in one side of the rectangle, particularly effective and uniform sonication is ensured owing to the turbulent flow conditions which prevail in the ultrasonic field, however, it is also possible and nondisadvantageous to employ a circular transmission means. Moreover, it is possible instead of a single ultrasound transmission means to arrange two or more separate transmission means which are connected in series as viewed in the flow direction. In such an arrangement it is possible for not only the emitting surfaces but also the depth of the reaction chamber, in other words the distance between the emitting surface and the floor of the through-flow channel, to vary.

With particular advantage, the means of transmitting ultrasonic waves is designed as a sonotrode whose end remote from the free emitting surface is coupled to an ultrasound transducer. The ultrasonic waves may be generated, for example, by exploiting the inverse piezoelectric effect. In this case, generators are used to generate high-frequency electrical oscillations (usually in the range from 10 to 100 kHz, preferably from 20 to 40 kHz), and these are converted by a piezoelectric transducer into mechanical vibrations of the same frequency and, with the sonotrode as transmission element, are coupled into the medium that is to be sonicated.

With particular preference, the sonotrode is designed as a rod-shaped, axially emitting λ/2 (or multiples of λ/2) longitudinal oscillator. A sonotrode of this kind may be fastened in an aperture of the housing by means, for example, of a flange provided on one of its nodes of oscillation. In this way the entry point of the sonotrode into the housing can be given a pressuretight design, so that the reaction chamber can be sonicated even under superatmospheric pressure. Preferably, the amplitude of oscillation of the sonotrode can be regulated, i.e., the particular oscillation amplitude set is monitored on-line and, if necessary, is corrected automatically. The current amplitude of oscillation can be monitored, for example, by means of a piezoelectric transducer mounted on the sonotrode, or by means of a strain gage with downstream evaluation electronics.

In accordance with a further advantageous design of such devices, the reaction chamber contains internals for improving the flow behavior and mixing behavior. These internals may comprise, for example, simple deflector plates or a wide variety of porous structures.

If required, mixing may be made more intensive by means of an additional stirrer unit. Advantageously, the temperature of the reaction chamber is controllable.

One preferred embodiment of the process of the invention comprises including all of the emulsion E1 in the initial charge to the polymerization vessel. The polymerization is started, for example, by adding at least a portion of the initiator and then heating the batch to the polymerization temperature. The remaining amount of initiator is then added continuously, in portions or all at once to the polymerization reaction. In a likewise preferred embodiment, the batch is first heated to the polymerization temperature and then the initiator is added in the manner described above.

In another embodiment of the process of the invention, a solution is first prepared from the monomers to be polymerized and the prepolymer and this solution, together with water and the major amount, preferably all, of the emulsifiers and any protective colloids, is converted into a conventional emulsion. This emulsion is then homogenized in the manner described above to form an emulsion E1. The resulting emulsion E1 is then introduced continuously, at constant or increasing feed rate, or in portions, preferably in accordance with the rate at which the polymerization progresses, into the polymerization vessel, which is at reaction temperature and contains the water and preferably a portion of the initiator, in particular from 1 to 20% of the total amount of initiator. The initiator is added in parallel with the monomer addition. The emulsion may be prepared in a separate stage before the polymerization or may be prepared continuously in accordance with the rate at which it is consumed, using for example the device described in DE 197 56 874.2.

The composition of the polymer preferably comprises at least 40% by weight, with particular preference at least 60% by weight, so-called principal monomers, selected from C₁-C₂₀ alkyl (meth)acrylates, vinyl esters of carboxylic acids containing up to 20 carbon atoms, vinylaromatic compounds having up to 20 carbon atoms, ethylenically unsaturated nitrites, vinyl halides, vinyl ethers of alcohols containing 1 to 10 carbon atoms, aliphatic hydrocarbons having 2 to 8 carbon atoms and 1 or 2 double bonds, or mixtures of these monomers.

Examples that may be mentioned include (meth)acrylic acid alkyl esters having a C₁-C₁₀ alkyl radical, such as methyl methacrylate, methyl acrylate, n-butyl acrylate, ethyl acrylate and 2-ethylhexyl acrylate.

In particular, mixtures of the (meth)acrylic acid alkyl esters are also suitable.

(Meth)acrylic acid alkyl esters having an alkyl radical >C₁₀, such as stearyl acrylate, are preferably used only in relatively small amounts.

Vinyl esters of carboxylic acids having 1 to 20 carbon atoms are for example vinyl laurate, vinyl stearate, vinyl propionate, Versatic acid vinyl ester, and vinyl acetate.

Vinylaromatic compounds include vinyltoluene, α- and p-methylstyrene, α-butylstyrene, 4-n-butylstyrene, 4-n-decylstyrene and, preferably, styrene.

Examples of nitrites are acrylonitrile and methacrylonitrile.

The vinyl halides are ethylenically unsaturated compounds substituted by chlorine, fluorine or bromine, preferably vinyl chloride and vinylidene chloride.

Examples of vinyl ethers are vinyl methyl ether and vinyl isobutyl ether. Vinyl ethers of alcohols containing 1 to 4 carbon atoms are preferred.

As hydrocarbons having 2 to 8 carbon atoms and two olefinic double bonds, mention may be made of butadiene, isoprene and chloroprene; those with one double bond are, for example, ethene or propene.

In addition to these principal monomers, the polymer may contain further monomers, examples being hydroxyl-containing monomers, especially C₁-C₁₀ hydroxyalkyl (meth)acrylates, (meth)acrylamide, ethylenically unsaturated acids, especially carboxylic acids, such as (meth)acrylic acid or itaconic acid, and their anhydrides, dicarboxylic acids and their anhydrides or monoesters, e.g., maleic acid, fumaric acid and maleic anhydride.

In general, ionic and/or nonionic emulsifiers and/or protective colloids and/or stabilizers are used as surface-active compounds during the emulsion polymerization.

A detailed description of appropriate protective colloids is given in Houben-Weyl, Methoden der organischen Chemie, Volume XIV/1, Makromolekulare Stoffe [Macromolecular substances], Georg-Thieme-Verlag, Stuttgart, 1961, pp. 411 to 420. Suitable emulsifiers include anionic, cationic and nonionic emulsifiers. Preferably accompanying surface-active substances used comprise exclusively emulsifiers, whose molecular weights, unlike those of the protective colloids are usually below 2000 g/mol. When using mixtures of surface-active substances, the individual components must of course be compatible with one another, something which in case of doubt can be checked by means of a few preliminary tests. Preferably, anionic and nonionic emulsifiers are used as surface-active substances. Common accompanying emulsifiers are, for example, ethoxylated fatty alcohols (EO units: 3 to 50, alkyl: C₈ to C₃₆), ethoxylated mono-, di- and tri-alkylphenols (EO units: 3 to 50, alkyl: C₄ to C₉), alkali metal salts of dialkyl esters of sulfosuccinic acid and also alkali metal salts and ammonium salts of alkyl sulfates (alkyl: C₈ to C₁₂), of ethoxylated alkanols (EO units: 4 to 30, alkyl: C₁₂ to C₁₈), of ethoxylated alkylphenols (EO units: 3 to 50, alkyl: C₄ to C₉), of alkylsulfonic acids (alkyl: C₁₂ to C₁₈) and of alkylarylsulfonic acids (alkyl: C₉ to C₁₈).

Further suitable emulsifiers may be found in Houben-Weyl, Methoden der organischen Chemie, Volume 14/1, Makromolekulare Stoffe [Macromolecular substances], Georg Thieme Verlag, Stuttgart, 1961, pages 192 to 208.

Examples of emulsifier tradenames are Dowfax® 2 A1, Emulan® NP 50, Dextrol® OC 50, Emulgator 825, Emulgator 825 S, Emulan® OG, Texapon® NSO, Nekanil® 904 S, Lumiten® I-RA, Lumiten E 3065, Steinapol NLS, etc.

The amount of emulsifier for preparing the aqueous emulsion E1 is chosen judicially in accordance with the invention so that within the aqueous phase the aqueous emulsion E1 that ultimately results the critical micelle concentration of the emulsifiers used is essentially not exceeded. Based on the amount of monomers in the aqueous emulsion E1, this amount of emulsifier is generally in the range from 0.1 to 5% by weight. As already mentioned, the emulsifiers may have added to them at the side protective colloids, which are able to stabilize the disperse distribution of the aqueous polymer dispersion that ultimately results. Independently of the amount of emulsifier used, the protective colloids may be used in amounts of up to 50% by weight, for example, in amounts from 1 to 30% by weight, based on the monomers to be polymerized.

Water-soluble initiators for the emulsion polymerization are, for example, ammonium salts and alkali metal salts of peroxodisulfuric acid, e.g., sodium peroxodisulfate, hydrogen peroxide, or organic peroxides, e.g., tert-butyl hydroperoxide.

Particularly suitable are what are known as reduction-oxidation (redox) initiator systems.

The redox initiator systems comprise at least one reducing agent and an oxidizing agent.

The oxidizing component comprises, for example, the emulsion polymerization initiators already mentioned above.

The reducing components comprise, for example, alkali metal salts of sulfurous acid, such as sodium sulfite, sodium hydrogen sulfite, alkali metal salts of disulfurous acid such as sodium disulfite, bisulfite addition compounds of aliphatic aldehydes and ketones, such as acetone bisulfite, or reducing agents such as hydroxymethanesulfinic acid and its salts, or ascorbic acid. The redox initiator systems may be used along with soluble metal compounds whose metallic component is able to exist in a plurality of valence states.

Customary redox initiator systems are, for example, ascorbic acid/iron(II) sulfate/sodium peroxodisulfate, tert-butyl hydroperoxide/sodium disulfite, tert-butyl hydroperoxide/Na hydroxymethanesulfinate. The individual components, e.g., the reducing component, may also be mixtures, for example, a mixture of the sodium salt of hydroxymethanesulfinic acid and sodium disulfite.

These compounds are usually used in the form of aqueous solutions, the lower concentration being determined by the amount of water which is acceptable in the dispersion and the upper concentration by the solubility of the respective compound in water.

In general, the concentration is from 0.1 to 30% by weight, preferably from 0.5 to 2.0% by weight, with particular preference from 1.0 to 10% by weight, based on the solution.

The amount of the initiators is generally from 0.1 to 10% by weight, preferably from 0.2 to 5% by weight, based on all the monomers to be polymerized. It is also possible to use two or more different initiators in the emulsion polymerization or else to use oil-soluble initiators.

Emulsification is preferably conducted at a rate such that at least 50% of all the NCO groups introduced are retained. Consequently, subsequent modification of the compounds P present is possible by way of their NCO groups, using the structural components c) and/or (d), for example.

The dispersions prepared by the process of the invention are suitable, for example, for adhesively bonding or for coating a variety of substrates such as wood, metal, plastics, paper, leather or textile, and for impregnating textiles.

Depending on the intended use, the aqueous dispersion may include additives such as thickeners, leveling assistants, pigments or fillers, fungicides etc.

The dispersion may also be cured additionally with customary crosslinkers. Crosslinking with water-emulsifiable polyisocyanates as described in EP 206 059 is possible; other crosslinkers, such as those based on aziridine, epoxide or carbodiimide, or polyvalent ions, may also be employed.

When used as an adhesive, the dispersions may include, besides the abovementioned additives, special auxiliaries and additives which are common in adhesive technology. Examples of these include thickeners, plasticizers and tackifying resins such as, for example, natural resins or modified resins such as rosin esters or synthetic resins such as phthalate resins.

Polymer dispersions used as an adhesive comprise with particular reference C₁-C₂₀ alkyl (meth)acrylates as principal monomers in the polymer (at least 40% by weight, particularly preferably at least 60% by weight, as stated above). Preferred applications in the adhesives segment include use as laminating adhesives, for example, for composite film lamination and high-gloss film lamination (adhesive bonding of transparent films with paper or cardboard).

The glass transition temperature of the polymers, in the case of use as an adhesive, is preferably set to levels less than 50° C., in particular less than 20° C., with particular preference less than 10° C. (ASTM 3418/82, “midpoint temperature” of the differential thermal analysis).

The dispersion may also be blended with other dispersions of polymeric compounds, such as free-radical addition polymers, polycondensates or polyadducts for example. The aqueous dispersion and its blends may be applied by customary techniques to the substrates that are to be coated or impregnated.

### EXAMPLE 1

1.1. Preparation of the Polyurethane Prepolymer Containing Isocyanate End Groups

180 g of a melt of a polyesterdiol prepared from adipic acid and 1,4-butanediol and having a hydroxyl number of 46 mg KOH/g were heated to 60° C. with 0.03 g of dibutyltin dilaurate, with stirring. Then 20.98 g of isophorone diisocyanate were added and the mixture was stirred at 72° C. until an NCO content of 0.95% was reached. The product was diluted with 240 g of n-butyl acrylate and cooled. It was diluted with a further 560 g of butyl acrylate.

1.2. Preparation of the Miniemulsion Polymer 1 by the Feed Technique:

A reaction vessel with stirrer was charged with an aqueous emulsifier solution of 3.60 g of Steinapol NLS (15% strength) (initial charge 1). 225 g of the solution of the PU prepolymer from Example 1.1 were added over the course of 2 minutes. The mixture was then stirred for a further 10 minutes. The resultant, conventional PU prepolymer-containing monomer emulsion was homogenized by means of ultrasound as already described above for 10 minutes. This miniemulsion was then introduced into a feed vessel 1 from which it could be added dropwise to the initial charge 2, consisting of 125 g of water, 0.54 g of Dissolvine and 2.16 g of feed stream 2 (1.80 g of sodium peroxodisulfate and 34.20 g of water). Initial charge 2 was charged to a polymerization vessel and heated to 80° C. with stirring. The initiator solution (1.80 g of sodium peroxodisulfate and 34.20 g of water) was introduced into feed vessel 2. After initial charge 2 had been heated to 80° C., feed stream 1, feed stream 2 and feed stream 3 (7.2 g of 10% strength sodium hydroxide solution) were commenced simultaneously and introduced into initial charge 2 over the course of 1 hour with stirring. Following the end of the addition of feed stream 1 and feed stream 2 to initial charge 2, polymerization was continued at 80° C. for 30 minutes and the batch was then cooled to 25° C. The properties of the dispersion thus obtained are as follows:

Solids content: 32.9%

dz value of dispersion: 298 nm

pH: 7.9

### EXAMPLE 2

2.1. Preparation of a PU Prepolymer Containing Isocyanate End Groups

182 g of a melt of a polyesterdiol prepared from adipic acid and 1,4-butanediol and having a hydroxyl number of 46 mg KOH/g were heated to 60° C. with 0.12 g of dibutyltin dilaurate, with stirring. Then 18.5 g of hexamethylene diisocyanate were added and the mixture was stirred at 74° C. until an NCO content of 1.4% was reached. The product was diluted with 240 g of n-butyl acrylate and cooled. It was diluted with a further 563 g of butyl acrylate.

2.2. Preparation of the Miniemulsion Polymer 2 by the Feed Technique:

A reaction vessel with stirrer was charged with an aqueous emulsifier solution of 3.60 g of Steinapol NLS (15% strength) (initial charge 1). 225 g of the solution of the PU prepolymer from Example 2.1 were added over the course of 2 minutes. The mixture was then stirred for a further 10 minutes. The resultant, conventional PU prepolymer-containing monomer emulsion was homogenized by means of ultrasound as already described above for 10 minutes. This miniemulsion was then introduced into a feed vessel 1 from which it could be added dropwise to the initial charge 2, consisting of 125 g of water, 0.54 g of Dissolvine and 2.16 g of feed stream 2 (1.80 g of sodium peroxodisulfate and 34.20 g of water). Initial charge 2 was charged to a polymerization vessel and heated to 80° C. with stirring. The initiator solution (1.80 g of sodium peroxodisulfate and 34.20 g of water) was introduced into feed vessel 2. After initial charge 2 had been heated to 80° C., feed stream 1, feed stream 2 and feed stream 3 (7.2 g of 10% strength sodium hydroxide solution) were commenced simultaneously and introduced into initial charge 2 over the course of 1 hour with stirring. Following the end of the addition of feed stream 1 and feed stream 2 to initial charge 2, polymerization was continued at 80° C. for 30 minutes and the batch was then cooled to 25° C. The properties of the emulsion and dispersion thus obtained are as follows:

Solids content: 33.6%

dz value of dispersion: 337 nm

pH: 8.0

We claim:

1. An aqueous dispersion of a polymer, obtainable by emulsion polymerization of free-radically polymerizable compounds (monomers), which comprises dissolving or dispersing in the monomer droplets dispersed in water compounds P containing urethane and/or urea groups and containing at least one reactive end group, said compounds P containing no carbodiimide groups.

2. An aqueous dispersion as claimed in claim 1, wherein said compounds P comprise polyurethane prepolymers containing NCO end groups.

3. An aqueous dispersion as claimed in claim 1 or 2, wherein said compounds P have an NCO content of from 0.1 to 10% by weight.

4. An aqueous dispersion as claimed in any of claims 1 to 3, wherein said compounds P carry no double bonds, apart from those in aromatic ring systems.

5. An aqueous dispersion as claimed in any of claims 1 to 4, wherein said compounds P contain no ionic groups and no polyalkylene oxide groups having more than 5 ethylene oxide units.

6. An aqueous dispersion as claimed in any of claims 1 to 5, wherein the emulsion polymer is obtainable by the method of miniemulsion polymerization, where the monomer droplets emulsified in water have a particle diameter of up to 1 μm and the compounds P are in solution or dispersion in these monomer droplets.

7. An aqueous dispersion as claimed in any of claims 1 to 6, wherein the polymer comprises in total at least 40% by weight principal monomers selected from C₁-C₂₀ alkyl meth(acrylates), vinylaromatic compounds having up to 20 carbon atoms, vinyl esters of carboxylic acids containing having 1 to 20 carbon atoms, ethylenically unsaturated nitrites, vinyl ethers of alcohols containing 1 to 10 carbon atoms, vinyl halides, nonaromatic hydrocarbons having 2 to 8 carbon atoms and one or two conjugated double bonds, or mixtures of these monomers.

8. A mixture of an aqueous dispersion as claimed in any of claims 1 to 7 with other aqueous dispersions based on addition polymers, polycondensates and polyadducts.

9. An aqueous dispersion as claimed in any of claims 1 to 8, comprising a crosslinker.

10. An aqueous dispersion as claimed in any of claims 1 to 9, wherein said crosslinker comprises a compound selected from the group consisting of polyisocyanates, aziridines, carbodiimides and epoxides.

11. A process for preparing an aqueous dispersion as claimed in any of claims 1-10.

12. The use of an aqueous dispersion as claimed in any of claims 1 to 10 as a binder for a coating composition or impregnating composition or for leather dressing.

13. The use of an aqueous dispersion as claimed in any of claims 1 to 10 as a binder in adhesives, varnishes, paints, paper coating slips or as a binder for fiber nonwovens.

14. The use of an aqueous dispersion as claimed in any of claims 1 to 10 as a binder for laminating adhesives.

15. A coating composition or impregnating composition comprising an aqueous dispersion as claimed in any of claims 1 to 10.

16. A substrate coated with an aqueous dispersion as claimed in any of claims 1 to 10.
